(19) United States
(12) Patent Application Publication
(10) Pub. No.: US 2013/0110829 A1
(43) Pub. Date: May 2, 2013

(54) Method and Apparatus of Ranking Search Results, and Search Method and Apparatus

(71) Applicant: Alibaba Group Holding Limited, Grand Cayman (KY)

(72) Inventor: Hengmin Zhou, Hangzhou (CN)

(73) Assignee: Alibaba Group Holding Limited, Grand Cayman (KY)

(21) Appl. No.: 13/664,831

(22) Filed: Oct. 31, 2012

(30) Foreign Application Priority Data
Oct. 31, 2011 (CN) 201110338609.6

(51) Int. Cl. G06F 17/30

(52) U.S. Cl. 707/728; 707/E17.014

(57) ABSTRACT

Described is a method and an apparatus for ranking search results and a search method and apparatus for solving the problem of inaccurate ranking when ranking search results found based on a long tail keyword. The method includes: determining one or more keyword elements related to a keyword; for each search result obtained based on the keyword, separately determining, from pre-stored corresponding relationships among keyword elements, search results and first relevance values which are used to measure relevance between the search results and the keyword elements, first relevance values that correspond to both the search results obtained and the one or more keyword elements determined based on the keyword, and separately determining second relevance values that are used to measure relevance between the keyword and the determined keyword elements; separately determining a ranking score of each search result obtained based on the keyword using the first relevance values and the second relevance values; and determining ranking information that is used to instruct a ranking order of the search results based on the ranking score of each search result.

### CROSS REFERENCE TO RELATED PATENT APPLICATION

This application claims foreign priority to Chinese Patent Application No. 201110338609.6 filed on Oct. 31, 2011, entitled “Method and Apparatus of Ranking Search Results, and Search Method and Apparatus,” which is hereby incorporated by reference in its entirety.

### TECHNICAL FIELD

The present disclosure relates to the field of data searching technologies, and particularly relates to methods and apparatuses of ranking search results, and search methods and apparatuses.

### BACKGROUND

In the field of Internet searching technologies, a keyword search corresponds to searching for, based on a search keyword (which is also called a query) that is inputted from a user, an index that matches with the search keyword from indices that are generated from an enormous amount of data by a search engine server, and presenting search results (i.e., found data) which correspond to the index to the user. When presenting the search results, the search results may first be ranked in accordance with respective relevance with the search keyword and then presented to the user.

Generally, a principle for ranking search results on a web page in which the search results are presented is to arrange the search results from top to bottom (or from front end to back end) in a descending order of relevance between the search results and associated search keyword. Because relevance values between the search results and the search keyword reflect degrees of relevance between the search results and a search intention of the user, an advantage of adopting the above ranking principle is that those results that represent the search intention of the user are shown at relatively higher (or more front end) positions in the web page. As such, these results may be more easily noticed by the user, thus improving the search experience of the user.

In order to achieve ranking of search results in accordance with a respective relevance between search results and a search keyword, existing technologies provide a number of ranking models, of which a relatively well-developed model is the “Effective Cost Per Mille (ECPM)” ranking model which obtains advertisement revenue by displaying search results in every thousand times and is abbreviated as ECPM model. The basic idea of the ECPM model is to calculate respective ranking scores of the search results and to determine a ranking order of the search results based on the calculated ranking scores. Specifically, this model employs an equation of calculating ranking scores such as Equation [1] below:

Sᵢ=Aᵢ^{γ}^{ᵢ}*Cᵢ [1]

where Sᵢ is a ranking score of an ith search result of a keyword search; Aᵢ is a relevance value which measures relevance between the ith search result and the keyword; γᵢ is a weight value used to adjust influence of Aᵢ on Sᵢ; Cᵢ is a data value of the highest advertisement revenue that can be obtained each time when the ith search result is presented.

Generally, Aᵢ can be calculated by substituting eigenvectors which correspond to a series of properties into a machine-learning model. Example property-related information is shown in Table 1 as follows:

TABLE 1

| No. | Property Name | Property Description | Property Weight | Eigenvectors |
|---|---|---|---|---|
| 1 | title Contain query | does a title of a search | w₁ | v₁ (the eigenvector is one |
| | | result include the query? | | when the title of the search |
| | | | | result contains the query; |
| | | | | otherwise the eigenvector is |
| | | | | zero) |
| 2 | relevance between an | | w₂ | v₂ (v₂ is a value representing |
| | information category | | | the relevance between the |
| | to which the search | | | information category to |
| | result belongs and the | | | which the search result |
| | query | | | belongs and the query) |
| 3 | relevance between an | | w₃ | v₃ (v₃ is a value representing |
| | information category | | | the relevance between the |
| | to which the search | | | information category to |
| | result belongs and a | | | which the search result |
| | specific bid word | | | belongs and the specified |
| | purchased by an | | | bid word purchased by the |
| | advertiser (generally, | | | advertiser) |
| | the specified bid word | | | |
| | is a word that has a | | | |
| | relative high degree of | | | |
| | matching with the | | | |
| | query or a keyword | | | |
| | element that is related | | | |
| | to the query) | | | |
| 4 | fMatchRatioUni | number of times that | w₄ | v₄ (v₄ is the number of times |
| | | each character in the | | that each character in the |
| | | query appears in the title | | query appears in the title) |
| 5 | fAprCat | relevance between an | w₅ | v₅ (v₅ is a value representing |
| | | information category to | | the relevance between the |
| | | which the query belongs | | information category to |
| | | and an information | | which the query belongs |
| | | category to which a head | | and the information |
| | | word of a title of a | | category to which the head |
| | | search result belongs | | word of the title of the |
| | | | | search result belongs) |
| 6 | relevance between the | | w₆ | v₆ (v₆ is a value representing |
| | query and a specified | | | the relevance between the |
| | bid word purchased by | | | query and the specified bid |
| | an advertiser | | | word purchased by the |
| | (generally, the | | | advertiser) |
| | specified bid word is a | | | |
| | word having a | | | |
| | relatively high degree | | | |
| | of matching with the | | | |
| | query or a keyword | | | |
| | element that is related | | | |
| | to the query) | | | |
| 7 | getQueryCatSimi | text relevance between | w₇ | v₇ (v₇ is a value |
| | | respective information | | representing the text |
| | | categories to which the | | relevance between |
| | | query and the search | | respective information |
| | | result belong | | categories to which the |
| | | | | query and the search |
| | | | | result belong) |
| 8 | a click feedback rate | | w₈ | v₈ |
| | associated with a | | | |
| | search result when the | | | |
| | query is used as a | | | |
| | search keyword in a | | | |
| | search | | | |
| . . . | . . . | . . . | . . . | . . . |
| n (n ≧ 1) | . . . | . . . | wₙ | vₙ |

For a particular keyword, in order to calculate a relevance value that reflects relevance between the keyword and an ith search result that is found based on the keyword, eigenvectors v₁˜vₙ in Table 1 may first be calculated, and weight values w₁˜wₙ may then be determined accordingly. Based on the values of v₁˜vₙ and w₁˜wₙ, Aᵢ may be determined using the following Equation [2]:

Aᵢ=v₁*w₁+v₂*w₂+v₃*w₃+ . . . +vₙ*wₙ, n≧1 [2]

Based on past experience, when vₙ (for example, v₈, etc.), which is related to click feedback, is used to calculate Aᵢ, vₙ usually has the greatest influence on a finally computed Aᵢ.

For a “top searched keyword” which is frequently inputted and includes relatively few keyword elements, eigenvectors, such as v₈, which are related to click feedback are comparatively accurate because a relatively large number of search results are usually found based on the top searched keyword. A better ranking scheme of the search results may therefore be obtained at the end. However, for a “long tail keyword” which is less frequently inputted and includes a higher number of keyword elements, the number of search results obtained in a search based on the long tail keyword is usually very few as compared with the top searched keyword. Eigenvectors that are related to click feedback are therefore hard to be determined based on these deficient search results. As such, relevance values, which are calculated based on the above Equation [2] to measure relevance between the search results and the keyword, are usually not accurate enough, leading to an inaccurate ranking of the search results. Furthermore, the inaccurate ranking results may cause the user to repeat the search, thus not only increasing the workload of a search server, but also increasing the occupancy of network bandwidth.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

Embodiments of the present disclosure provide a method and an apparatus of ranking search results in order to solve the problems of inaccurate ranking when existing technologies are used to rank search results that are found for a long tail keyword so that the workload of a search server and the occupancy of network bandwidth may be reduced.

Embodiments of the present disclosure further provide a search method and apparatus.

The embodiments of the present disclosure adopt the following technical scheme:

A method of ranking search results includes: determining keyword elements related to a keyword; for each search result obtained based on the keyword, respectively determining, from pre-stored corresponding relationships among keyword elements, search results and first relevance values which are used to measure relevance between the search results and the keyword elements, first relevance values that correspond to both the search results obtained and the keyword elements determined based on the keyword, and respectively determining second relevance values that are used to measure relevance between the keyword and the determined keyword elements; respectively determining a ranking score of each search result obtained based on the keyword using the first and second relevance values; and determining ranking information that is used to instruct a ranking order of the search results based on the ranking score of each search result.

A search method includes: receiving a search request containing a keyword; finding related search results based on the keyword and determining ranking information used for instructing a ranking order of the search results; sending the search results and the ranking information to a sender's apparatus corresponding to the search request and instructing the sender's apparatus to order the search results in accordance with the ranking information, where the ranking information may be determined using the foregoing method of ranking search results.

An apparatus of ranking search results includes: a keyword element determination unit configured to determine keyword elements related to a keyword; a first relevance value determination unit configured to, for each search result obtained based on the keyword, respectively determining, from pre-stored corresponding relationships among keyword elements, search results and first relevance values which are used to measure relevance between the search results and the keyword elements, first relevance values that correspond to both the search results obtained and the keyword elements determined based on the keyword, and respectively determining second relevance values that are used to measure relevance between the keyword and the keyword elements determined by the keyword element determination unit; a second relevance value determination unit configured to respectively determine second relevance values that are used to measure relevance between the keyword and the keyword elements determined by the keyword element determination unit; a ranking score determination unit configured to respectively determine a ranking score of each search result obtained based on the keyword using the first relevance values determined by the first relevance value determination unit and the second relevance values determined by the second relevance value determination unit; and a ranking unit configured to determine ranking information used to instruct a ranking order of the search results in accordance with the ranking score of each search result determined by the ranking score determination unit.

A search apparatus includes: a search request receiving unit configured to receive a search request containing a keyword; a search unit configured to find related search results based on the keyword contained in the search request that is received by the search request receiving unit; a ranking information determination unit configured to determine ranking information that is used for instructing a ranking order of the search results found by the search unit; a sending unit configured to send the search results obtained by the search unit and the ranking information determined by the ranking information determination unit to a sender's apparatus corresponding to the search request and instruct the sender's apparatus to order the search results in accordance with the ranking information, where the ranking information determination unit may include the foregoing apparatus of ranking search results.

The advantages of the embodiments of the present disclosure are as follows:

Using the technical scheme provided by the embodiments of the present disclosure, when ranking scores of search results corresponding to a long tail keyword are determined, relevance values which measure relevance between the long tail keyword and the search results do not need to be computed directly. Rather, the relevance between the long tail keyword and the search results is transformed into relevance between the long tail keyword and keyword elements as well as relevance between the keyword elements and the search results. Since the number of search results obtained based on the keyword elements is usually larger than the number of search results obtained based on the long tail keyword, eigenvectors which are related to click feedback and are used in calculating relevance values that measure the relevance between the keyword elements and the search results are comparatively accurate. Therefore, the accuracy of the ranking scores and hence the accuracy of the search results ranking are improved, thus reducing the workload of search servers and the occupancy of network bandwidth.

### BRIEF DESCRIPTION OF THE DRAWINGS

FIG. 1 shows a flowchart illustrating a method of ranking search results provided in the embodiments of the present disclosure.

FIG. 2 shows a structural diagram illustrating a system for implementing the technical scheme provided in the embodiments of the present disclosure.

FIG. 3 shows a flowchart illustrating the example method in practice.

FIG. 4 shows a structural diagram of an apparatus of ranking search results provided in the embodiments of the present disclosure.

FIG. 5 shows a structural diagram of the example apparatus as described in FIG. 4.

### DETAILED DESCRIPTION

To overcome the problem of inaccurate ranking when existing technologies are used to rank search results that are found for a long tail keyword, the embodiments of the present disclosure provide a method of ranking search results. By transforming relevance between a long tail keyword and search results into relevance between the long tail keyword and keyword elements as well as relevance between the keyword elements and the search results, eigenvectors that are related to click feedback and are used in calculating relevance values become more accurate. Therefore the accuracy of ranking scores may be improved, thus improving the accuracy of ranking of the search results.

Specific processes of implementing methods provided in the embodiments of the present disclosure are described in detail below in conjunction with the accompanying figures.

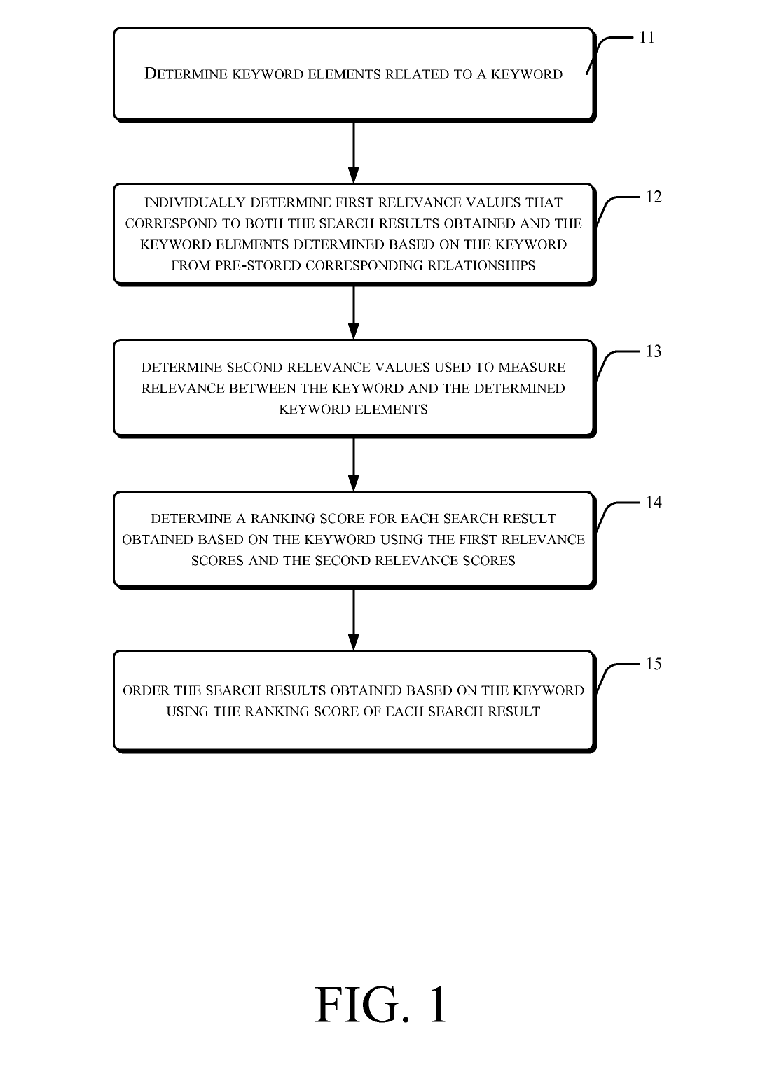

FIG. 1 shows a flowchart illustrating a method of ranking search results provided in the embodiments of the present disclosure, which includes the following procedures.

Block 11 determines keyword elements related to a keyword.

In the present embodiment, keyword elements related to a keyword that is sent from a user client may be determined using technologies including, but not limited to, Query Rewrite (QR), etc. Generally, other than keyword elements that are generated by splitting the keyword, determined keyword elements may also include one or more types as follows: keyword elements remaining after removing special characters from the keyword, keyword elements that have meanings close to the keyword, keyword elements determined to be related to an information category to which the keyword belongs, keyword elements that are determined based on probabilities of co-occurrence of other keywords and the keyword, etc. Specifically, for an English keyword, the determined keyword elements may further include keyword elements that are obtained after case conversion of the letters of the keyword.

Generally, the number of characters included in the keyword elements is fewer than the number of characters included in the keyword itself. Therefore, the number of search results obtained based on the keyword elements is usually more than the number of search results obtained based on the keyword.

Block 12, for each search result obtained based on the keyword, individually determines, from pre-stored corresponding relationships among the keyword elements, search results and first relevance values used to measure relevance between the search results and the keyword elements, first relevance values that correspond to both the search results obtained and the keyword elements determined based on the keyword.

In this embodiment, in order to ensure the efficiency of computing ranking scores of the search results, the first relevance values which are used to measure the relevance between the search results and the keyword elements may be calculated and stored in advance. When the ranking scores of the search results are calculated at a later stage, first relevance values that correspond to the search results obtained based on the keyword may be selected directly from the stored first relevance values. It should be noted that, keyword elements which are referenced when calculating the first relevance values may be generated statistically based on keywords which have previously been inputted by users to a search engine. Such keywords may be all keywords that have previously been inputted to the search engine and/or keywords having an input rate higher than a pre-determined threshold among keywords inputted to the search engine, etc.

Specifically, the first relevance values may be calculated using a Gradient Boosted Decision Tree (GBDT) model or a linear model, which are relatively well-developed in existing technologies. Specific examples of using these two models to calculate a first relevance values are provided in subsequent sections and are not redundantly described herein. Upon calculating the first relevance values using the above models, corresponding relationships among the keyword elements, the search results, and the first relevance values which are used to measure the relevance between the search results and the keyword elements may be stored accordingly in order to provide data support when the ranking scores of the search results are calculated at a later stage.

Block 13 determines second relevance values that are used to measure relevance between the keyword and the determined keyword elements.

In this embodiment, a number of methods may be used to calculate the second relevance values. For example, a second relevance value may be calculated based on text relevance between a keyword and a keyword element, relevance between information categories to which respective parties belong, or a probability of co-occurrence (abbreviated as co-occurrence probability).

A specific approach of calculating second relevance values based on text relevance includes: determining text coincidence values that measure degrees of text coincidence between the keyword and the keyword elements, and determining, based on the determined text coincidence values, second relevance values corresponding to the text coincidence values from pre-configured corresponding relationships between the second relevance values and the text coincidence values.

A specific approach of calculating second relevance values based on category relevance includes: calculating the second relevance values based on degrees of relevance between respective information categories to which the keyword and the keyword elements belong.

A specific approach of calculating a second relevance value based on a co-occurrence probability includes: calculating the second relevance value based on a probability that the keyword and a keyword element co-occur in a same text.

Details of implementing these calculation methods are described in subsequent example embodiments and therefore are not redundantly described herein.

It should be noted that the above order of execution of block 12 and block 13 may be reversed. Also, block 12 and block 13 may be executed in parallel.

Block 14 determines a ranking score for each search result that is found based on the keyword using the first relevance scores and the second relevance scores.

In this embodiment, block 14 may be implemented in many different approaches. Below provides a description of implementation processes of these approaches.

First Approach:

For each search result that is found based on the keyword, the following process is performed:
first, for each determined keyword element, determining a data value of the highest advertisement revenue each time when the search result is presented with this keyword element is used as a keyword;
next, for each determined keyword element, determining a ranking score of the search result based on a first relevance value used to measure relevance between the search result and the keyword element, a second relevance value used to measure relevance between the keyword and the keyword element and a corresponding data value of the highest advertisement revenue; and
last, selecting, from the determined ranking score of each keyword element, the highest score as a ranking score associated with the search result.

Second Approach:

The second approach is different from the first approach of determining a ranking score of a search result based on a first relevance value used to measure relevance between the search result and a keyword element, a second relevance value used to measure relevance between a keyword and the keyword element and a corresponding data value of the highest advertisement revenue for each determined keyword element, and may include the following procedures:
first, for each determined keyword element, determining a category property score used to measure relevance between an information category to which the search result belongs and an information category to which the keyword element belongs; and
next, for each determined keyword element, determining a ranking score of the search result based on a first relevance value used to measure relevance between the search result and the keyword element, a second relevance value used to measure relevance between the keyword and the keyword element, a corresponding data value of the highest advertisement revenue and the corresponding category property score.

Third Approach:

The third approach is different from the first approach of determining a ranking score of a search result based on a first relevance value used to measure relevance between the search result and a keyword element, a second relevance value used to measure relevance between a keyword and the keyword element and a corresponding data value of the highest advertisement revenue for each determined keyword element, and may include the following procedures:
for each determined keyword element, determining a click rate of the search result when that keyword element is used as a keyword; and
for each determined keyword element, determining a ranking score of the search result based on a first relevance value used to measure relevance between the search result and the keyword element, a second relevance value used to measure relevance between the keyword and the keyword element, a corresponding data value of the highest advertisement revenue and the click rate.

Fourth Approach:

The fourth approach is different from the third approach of determining a ranking score of a search result based on a first relevance value used to measure relevance between the search result and a keyword element, a second relevance value used to measure relevance between a keyword and the keyword element, a corresponding data value of the highest advertisement revenue and a click rate for each determined keyword element, and may include the following procedures:
first, for each determined keyword element, determining a category property score used to measure relevance between an information category to which the search result belongs and an information category to which the keyword element belongs; and
then, for each determined keyword element, determining a ranking score of the search result based on a first relevance value used to measure relevance between the search result and the keyword element, a second relevance value used to measure relevance between the keyword and the keyword element, a corresponding data value of the highest advertisement revenue, a corresponding click rate and the category property score.

For a long tail keyword, the number of search results obtained based thereupon is very few. In view of these few search results, a user may either give up clicking any search results because the number of search results does not meet the user's expectation, or ignore his/her search intention and click the search results one by one. This usually makes it difficult for the above click rate to measure its relationship with a user's search intention in reality. Thus, the first and the second approaches are preferably employed in this embodiment. The commonality of these two approaches is that the influence of a click rate is not included in calculation of a ranking score.

Block 15 determines ranking information used to instruct a ranking order of the search results obtained based on the keyword using the ranking score of each search result.

In this embodiment, a primary entity to implement this block may be a search engine apparatus, or a search result ranking apparatus that is dedicated to rank the search results and is independent of and separate from the search engine apparatus.

Using the above technical scheme provided by the embodiments of the present disclosure, for a long tail keyword, equations such as Equation [1] of directly computing relevance values that measure relevance between the long tail keyword and corresponding search results may not be needed. Instead, the relevance between the long tail keyword and the search results is transformed into relevance between the long tail keyword and keyword elements as well as relevance between the keyword elements and the search results. Since the number of search results obtained based on the keyword elements is usually larger than the number of search results obtained based on the long tail keyword, eigenvectors that are related to click feedback and are used in calculating relevance values which measure the relevance between the keyword elements and the search results are comparatively accurate. Therefore, the accuracy of the ranking scores and hence the accuracy of the search results ranking are improved, thus reducing the workload of search servers and the occupancy of network bandwidth.

Based on the above example method for ranking search results, the embodiments of the present disclosure further provide a search method. This method may specifically include the following procedures:
first, receiving a search request containing a keyword;
then, finding corresponding search results based on the keyword contained in the search request and determining ranking information that is used for instructing a ranking order of the found search results, where the ranking information may be determined using the method of ranking search results as provided in the embodiments of the present disclosure, i.e. the method as shown in FIG. 1 or methods derived from that method; and
last, sending the found search results and the determined ranking information to a sender's apparatus corresponding to the search request and instructing the sender's apparatus to order the found search results in accordance with the ranking information.

Through the search method provided in this embodiment, the number of search results obtained based on keyword elements is usually larger as compared with the number of search results obtained based on a long tail keyword. Therefore, the ranking information determined using the method as shown in FIG. 1, for example, or methods derived from that method, are more accurate. As such, the sender's apparatus may perform a more accurate ranking of the search results based on such ranking information, thus avoiding the problem of wasting a large amount of system resource that is caused by repeatedly sending search requests by the sender's apparatus to obtain an accurate ranking result due to inaccurate ranking of the search results.

Processes of implementing the above schemes that are provided in the embodiments of the present disclosure are described in details below in combination with practicality.

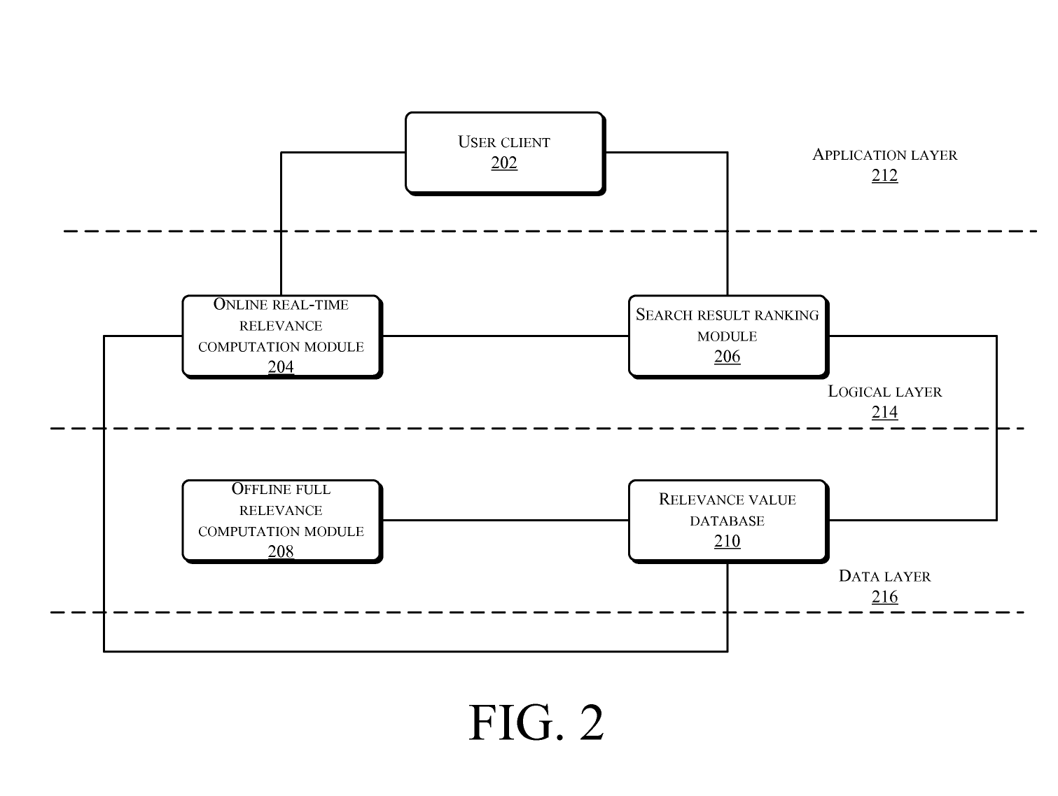

A system architecture established for performing the above schemes is first introduced herein. The system architecture is illustrated in FIG. 2 and may be divided into an application layer 212, a logical layer 214 and a data layer 216.

A main apparatus at the application layer is a user client 202, which is configured to receive a keyword inputted from a user through a user interface, and is further configured to rank and present search results that are found based on the inputted keyword according to ranking information that is sent from a search result ranking module of the logical layer.

Main apparatuses at the logical layer are an online real-time relevance computation module 204 and the search result ranking module 206. The online real-time relevance computation module 204 is mainly configured to determine the keyword elements related to the keyword that is received from the user client 202 of the application layer and determine respective second relevance values used to measure relevance between the keyword and the keyword elements. Furthermore, the online real-time relevance computation module 206 is configured to determine, based on corresponding relationships among three parties (the keyword elements, the search results and first relevance values used to measure relevance between the keyword elements and the search results) that are stored in a relevance value database at the data layer, first relevance values which correspond to both the keyword elements related to the keyword and the search results obtained based on the keyword, and perform an operation of determining a ranking score based on a corresponding first relevance value and a corresponding second relevance value for each of the search results that are obtained based on the keyword. It should be noted that a relationship between a keyword and a keyword element is that: the keyword has a same or similar meaning as a keyword element and the keyword may usually be divided into multiple keyword elements. For example, a keyword “People's Bank of China” may be split into such keyword elements as “China”, “people”, “bank”, “people of China”, “people's bank”, “bank of China”, etc. The search result ranking module 206 included in the logical layer may be mainly configured to determine ranking information that is used to instruct a ranking order of the search results based on the ranking scores that are obtained by the online real-time relevance computation module 204.

Main apparatuses at the data layer are an offline full relevance computation module 208 and the relevance value database 210. The offline relevance value computation module 208 is configured to calculate relevance values between the keyword elements and search results that are obtained based on the keyword elements. The relevance value database 210 is a storage device and is configured to store the keyword elements, the search results and the relevance values obtained by the offline relevance value computation module 208 correspondingly.

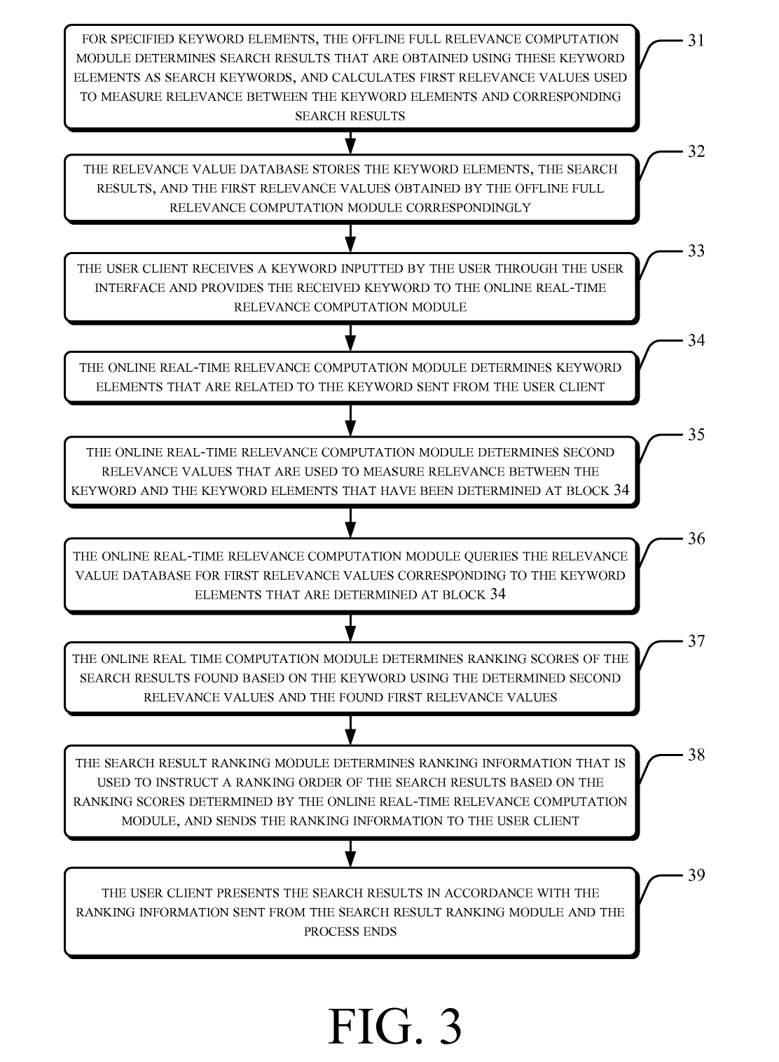

Based on the system architecture illustrated in FIG. 2, details of a process of implementing the method provided in the embodiments of the present disclosure in practice may be divided into blocks as illustrated in FIG. 3. These blocks can generally be divided into two parts, where block 31 and block 32 are offline processing blocks, the purpose of which is to determine and store relevance values between keyword elements and corresponding search results in order to provide data support for subsequent determination of ranking scores. Blocks 33-39 are online processing blocks, the purposes of which are to determine ranking scores of the search results that are found based on the keyword using the relevance values determined at the offline processing blocks, and to rank the search results in accordance with the ranking scores.

These blocks are described in detail hereinafter.

At block 31, for specified keyword elements, the offline full relevance computation module determines search results that are obtained using these keyword elements as search keywords, and calculates first relevance values used to measure relevance between the keyword elements and corresponding search results.

A computation model for computing first relevance values may be a GBDT model or a linear model, etc. Since these models are relatively well-developed and frequently used models in existing technologies, only a brief description of their implementation principles are provided below.

The GBDT model is a computation model made up of multiple (usually more than one hundred) decision trees. When calculating a first relevance value, a prediction of an initial value of the first relevance value is first assigned to an eigenvector which is inputted into the GBDT model (e.g., any of the eigenvectors v₁˜vₙ in Table 1), and then each of the decision trees in the model is traversed to adjust this initial first relevance value in order to obtain the first relevance value that is used to measure relevance between a keyword element and a search result. Taking a first relevance value Xᵢⱼ which is used to measure relevance between a jth keyword element and an ith search result obtained based on the jth keyword element as an example. According to the GBDT model, Xᵢⱼ may be calculated as shown in the following Equation [3]:

X_{i,j}=X_{i,j}⁰+θ₁T₁(v_{z})+θ₂T₂(v_{z})+θ₃T₃(v_{z})+ . . . +θₗTₗ(v_{z})+ . . . +θₖTₖ(v_{z}) [3]

where v_{z} is an eigenvector inputted into the GBDT model, X_{i,j}⁰ is an initial first relevance value assigned to eigenvector v_{z} of the GBDT model, k is the number of decision trees included in the GBDT model, θₗ is a weight of a lth decision tree, where l satisfies 1≦l≦k, Tᵢ(v_{z}) is an adjustment function used by the lth decision tree to adjust the initial first relevance value.

Besides the above GBDT model, the first relevance values may alternatively be calculated using a linear model. Generally, a method of calculating first relevance values using a linear model is relatively simple and can usually be performed by computing a weighted sum of eigenvectors. Specific equations may refer to Equation [2] in the foregoing section and are not redundantly described herein.

At block 32, the relevance value database stores the keyword elements, the search results, and the first relevance values obtained by the offline full relevance computation module correspondingly.

The purpose for the relevance value database to store the first relevance values, the search results and the keyword elements correspondingly is to provide data support for the online real-time relevance computation module in determining ranking scores of the search results.

For a jth keyword element, an approach of storing it correspondingly with a corresponding search result and a corresponding first relevance value is shown in Table 2:

TABLE 2

| Keyword | Search | First |
|---|---|---|
| Element | Result | Relevance Value |
| 1st keyword | . . . | . . . |
| element | | |
| . . . | . . . | . . . |
| jth keyword | 1st | X_{1, j} |
| element | search result | |
| | 2nd | X_{2, j} |
| | search result | |
| | . . . | . . . |
| | rth | X_{r, j} |
| | search result | |
| | . . . | . . . |
| . . . | . . . | . . . |

At block 33, the user client receives a keyword inputted by the user through the user interface and provides the received keyword to the online real-time relevance computation module.

At block 34, the online real-time relevance computation module determines keyword elements related to the keyword that is sent from the user client.

At block 34, the online real-time relevance computation module may determine keyword elements related to the keyword that is sent from the user client using technologies such as QR. Generally, other than keyword elements that are generated by splitting the keyword, determined keyword elements may also include one or more types as follows: keyword elements remaining after removing special characters from the keyword, keyword elements that have meanings close to the keyword, keyword elements determined to be related to an information category to which the keyword belongs, keyword elements that are determined based on probabilities of co-occurrence of other keywords and the keyword, etc. In particular, for an English keyword, the determined keyword elements may further include keyword elements that are obtained after case conversion of the letters of the keyword.

A commonality among keyword elements that are determined for a same keyword is an existence of certain relevance between these keyword elements and the keyword. This relevance may be measured from different perspectives. For example, degrees of coincidence between search results of the keyword elements and search results of the keyword may be used to intuitively determine relevance between the keyword elements and the keyword: the higher the degree of coincidence is, the higher the relevance is. The opposite means that the relevance is lower.

At block 35, the online real-time relevance computation module determines second relevance values that are used to measure relevance between the keyword and the keyword elements that have been determined at block 34;

In this embodiment, a second relevance value may be calculated in many different ways. For example, a second relevance value may be calculated based on text relevance between the keyword and a keyword element, relevance between respective information categories to which the keyword and the keyword element belong or a probability of co-occurrence of the keyword and the keyword element (abbreviated as occurrence probability).

A specific approach of using text relevance to calculate a second relevance values includes: determining a text coincidence value that is used to measure a degree of text coincidence between the keyword and each keyword element, and based on the determined text coincidence values, selecting a second relevance value corresponding to each text coincidence value from pre-configured corresponding relationships between the second relevance values and the text coincidence values. When the corresponding relationships between the second relevance values and the text coincidence values are set up, a reference rule may include: the higher the text coincidence value is, the larger the corresponding second relevance value is; otherwise, the lower the text coincidence value is, the smaller the corresponding second relevance value is. In other words, an ascending order of text coincidence values corresponds to an ascending order of second relevance values. If such a corresponding relationship is not set up in advance, the text coincidence value may directly be treated as corresponding second relevance value. An example of calculating second relevance values using text coincidence values is described as follows.

Given a keyword “ [symbol] (National Geological Park)”, determined keyword elements related thereto may be assumed to be “ [symbol] (Geological Park)” and “ [symbol] [symbol] (Nation)”. Therefore, “ [symbol] (National Geological Park)” and “ [symbol] (Geological Park)” may be determined to have four characters in common, from which a text coincidence value may be assumed to be four. Similarly, “ [symbol] (National Geological Park)” and “ [symbol] (Nation)” may be determined to have two characters in common, and therefore the text coincidence rate may be assumed to be two. Based on the determined coincidence values (four and two), respective second relevance values corresponding to the text coincidence values (four and two) may be determined from corresponding relationships between the second relevance values and the text coincidence values that are pre-configured in accordance with a rule of corresponding an ascending order of text coincidence values with an ascending order of second relevance values.

Furthermore, a specific approach of calculating a second relevance value based on relevance of information categories includes: determining a second relevance value based on relevance between respective information categories to which the keyword and the keyword element belong. Generally, if an information category to which the keyword belongs and an information category to which the keyword element belongs are similar or have a hierarchical relationship, corresponding second relevance value may be obtained. For example, if a keyword belongs to an information category of “women's clothing”, a keyword element determined to be related thereto may belong to an information category of “dress”. Since the information category of “dress” is an information sub-category under the information category of “women's clothing”, a hierarchical relationship is established between these two information categories of “dress” and “women's clothing”, and the information category of “women's clothing” is at a level higher than the information category of “dress”. Under this circumstance, a second relevance value used to measure relevance between the keyword and the keyword element may be determined. Specifically, the second relevance value may be calculated according to a distance associated with this hierarchical relationship. For example, the greater the number of levels which are in between the information category to which the keyword belongs and the information category to which keyword element belongs is, the smaller the second relevance value will be. Alternatively, the second relevance value may be calculated based on whether the information category of the keyword is higher or lower than the information category of the keyword element. For example, if the level of the information category to which the keyword belongs is higher than the level of information category to which a first keyword element belongs, but is lower than the level of information category to which a second keyword element belongs, a second relevance value which is used to measure relevance between the keyword and the first keyword element may be set to be greater than a second relevance value which is used to measure relevance between the keyword and the second keyword element.

Besides the above calculation methods, a specific approach of calculating a second relevance value using a co-occurrence probability may include: calculating the second relevance value based on a probability that the keyword and the keyword element co-occur in a same text. A specific equation is shown as Equation [4] below:

$${Y}_{j} = \frac{2 {H}_{j}}{{H}_{0 j} * {H}_{1 j}} \qquad [ 4 ]$$

where Yⱼ is a second relevance value which measures relevance between the keyword and a jth keyword element related thereto, Hⱼ is the number of times that the keyword and the jth keyword element co-occur in a same text collection, H₀ⱼ is the number of times that the keyword occurs in that text collection, H₁ⱼ is the number of times that the jth keyword element occurs in that text collection.

At block 36, the online real-time relevance computation module queries the relevance value database for first relevance values corresponding to the keyword elements that are determined at block 34.

For example, for a jth keyword element, the online real-time relevance computation module may find r number of the first relevance values, X_{1,j}˜X_{r,j}, from corresponding relationships (as shown in Table 2, for example) stored in the relevance value database. Similarly, first relevance values for other keyword elements that are related to the keyword may also be found accordingly.

At block 37, the online real time computation module determines ranking scores of the search results that are found based on the keyword using the determined second relevance values and the found first relevance values.

In this embodiment, multiple methods may exist to determine the ranking scores of the search results. An ith search result of which a ranking score is to be determined and a jth keyword element related to the keyword are used as an example. If a first relevance value Xᵢⱼ which measures relevance between the jth keyword element and the ith search result is found, a ranking score Sᵢ of the ith search result with respect to the jth keyword element may be determined based on Xᵢⱼ, a second relevance Yᵢ which is used to measure relevance between the jth keyword element and the keyword, a click rate Qᵢ which is associated with the ith search result when the jth keyword element is used as a keyword of search, and a data value Cᵢ of the highest advertisement revenue obtained each time when the ith search result is presented with the jth keyword element being used as a keyword of search. A specific equation may be referenced to Equation [5] as follows:

Sᵢ=Xᵢⱼ*Yⱼ*Qᵢ^{β}^{ᵢ}*Cᵢ [5]

where βᵢ is a weight used to adjust the influence of Qᵢ on Sᵢ. It should be noted that Qᵢ is usually a statistical value. For example, when a user uses the jth keyword element as a keyword of search that reflects his/her search intention to conduct multiple searches, the number of times that an ith search result is presented and the number of times that the ith search result is clicked may be analyzed statistically. A click rate associated with the search result may then be calculated from these numbers.

Alternatively, the ranking score Sᵢ of the ith search result may be determined based on the first relevance value Xᵢⱼ, the second relevance value Yⱼ the click rate Qᵢ associated with the ith search result when the jth keyword element is used as the keyword of search, the data value Cᵢ of the highest advertisement revenue each time when the ith search result is presented with the jth keyword element being used as the keyword of search and a category property score Dᵢ. The category property score Dᵢ refers to a value that measures relevance between an information category to which an ith search result belongs and an information category to which a jth keyword element belongs. Specifically, an equation for calculating Sᵢ may refer to the following Equation [6]:

Sᵢ=X*Y*Dᵢ*Qᵢ^{β}^{ᵢ}*C [6]

For a long tail keyword, the number of search results obtained based thereupon is very few. In view of these few search results, a user may either give up clicking any search results because the number of search results does not meet the user's expectation, or ignore his/her search intention and click the search results one by one. This usually makes it difficult for Qᵢ to measure its relationship with a user's search intention in reality. Thus, when Sᵢ is calculated in this embodiment, Qᵢ may be removed from the above equations. By removing Qᵢ, the above Equation [5] and [6] may be transformed as Equation [7] and [8]:

Sᵢ=X*Y*Cᵢ [7]

Sᵢ=X*Y*Dᵢ*Cᵢ [8]

Alternatively, the present embodiment may employ a simplified equation such as Equation [9] below to calculate Sᵢ:

Sᵢ=X*Y [9]

Through the above calculation, ranking scores of different keyword elements with respect to a same search result may be calculated. In this embodiment, for any search result, the real-time relevance computation module may, but is not limited to, select the highest ranking score from a plurality of calculated ranking scores corresponding to that search result as the ranking score of that search result. As such, only one ranking score may be determined for each search result as the basis for ranking at the end.

At block 38, the search result ranking module determines ranking information that is used to instruct a ranking order of the search results based on the ranking scores determined by the online real-time relevance computation module, and sends the ranking information to the user client.

In this embodiment, the ranking information is specifically used for instructing a ranking order of the search results. For example, ten search results are assumed to be found based on a keyword (assuming that numbers 1˜10 represent different search results respectively). Further, a ranking order based on ranking scores of the search results is “2, 1, 5, 8, 3, 4, 9, 10, 7, 6”, of which corresponding ranking information may be treated as ranking information that instructs this ranking order.

At block 39, the user client presents the search results in accordance with the ranking information that is sent from the search result ranking module. The process ends.

Due to the characteristics of the above scheme of ranking search results, the ranking model adopted by the scheme in the embodiments may be called a “two-part ranking model”. One part of the “two-part” refers to an online computation of second relevance values which are used to measure relevance between a keyword and keyword elements in real time, and the other part refers to an offline full computation of first relevance value used to measure relevance between the keyword elements and search results.

Using the above technical scheme provided by the embodiments of the present disclosure, for a long tail keyword, equation such as Equation [1] of directly computing relevance values that measure relevance between the long tail keyword and the search results may not be needed. Instead, the relevance between the long tail keyword and the search results is transformed into relevance between the long tail keyword and keyword elements as well as relevance between the keyword elements and the search results. Since the number of search results obtained based on the keyword elements is usually larger than the number of search results obtained based on the long tail keyword, eigenvectors that are related to click feedback and are used in calculating relevance values which measure the relevance between the keyword elements and the search results are comparatively accurate. Therefore, the accuracy of the ranking scores is improved, thus indirectly improving the accuracy of the rankings of the search results.

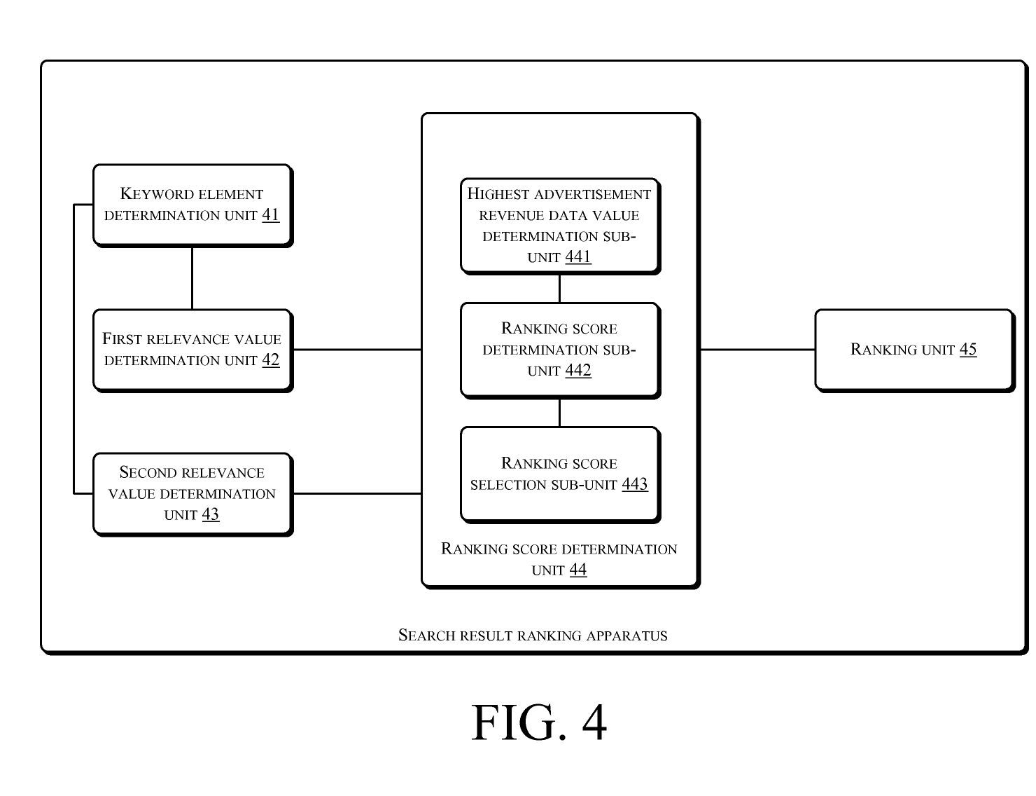

In order to solve the problem of a possibly inaccurate ranking when existing technologies are used to rank search results that are found based on a long tail keyword, the embodiments of the present disclosure further provide an apparatus for ranking search results which corresponds to the above methods of ranking search results. A specific structure of the apparatus is shown in FIG. 4, and includes the following functional units:
a keyword element determination unit 41 configured to determine keyword elements related to a keyword;
a first relevance value determination unit 42 configured to, for each search result obtained based on the keyword, separately determine, from pre-stored corresponding relationships among keyword elements, search results and first relevance values which are used to measure relevance between the search results and the keyword elements, first relevance values that correspond to both the search results obtained and the keyword elements determined based on the keyword, and separately determine second relevance values that are used to measure relevance between the keyword and the keyword elements determined by the keyword element determination unit 41;
a second relevance value determination unit 43 configured to separately determine second relevance values that are used to measure relevance between the keyword and the keyword elements determined by the keyword element determination unit 41;
a ranking score determination unit 44 configured to separately determine a ranking score of each search result obtained based on the keyword using the first relevance values determined by the first relevance value determination unit 42 and the second relevance values determined by the second relevance value determination unit 43; and
a ranking unit 45 configured to determine ranking information used to instruct a ranking order of the search results in accordance with the ranking score of each search result determined by the ranking score determination unit 44.

Optionally, corresponding to an implementation of the functions of the ranking score determination unit 44, this unit may be divided into functional sub-units as illustrated in FIG. 4, which include:
a highest advertisement revenue data value determination sub-unit 441, configured to determine, for each search result found and each keyword element determined based on the keyword, a data value of the highest advertisement revenue obtained each time when the search result is presented with the keyword element being as a keyword of search;
a ranking score determination sub-unit 442, configured to determine, for each search result found and each keyword element determined based on the keyword, a ranking score of the search result based on the first relevance value used to measure the relevance between the search result and the keyword element, the second relevance value used to measure the relevance between the keyword and the keyword element, and the data value of the highest advertisement revenue determined by the highest advertisement revenue data value determination sub-unit 441;
a ranking score selection sub-unit 443, configured to select the highest ranking score from the ranking of the keyword elements determined by the ranking score determination sub-unit 442 as a ranking score of associated search result.

Optionally, corresponding to an implementation of the functions of the ranking score determination sub-unit 442, the unit may be divided into the following functional modules, which include:
a category property score determination module, configured to determine, for each search result found and each keyword element determined based on the keyword, a category property score value which measures relevance between an information category to which the search result belongs and an information category to which the keyword element belongs; and
a ranking score determination module, configured to determine, for each search result found and each keyword element determined based on the keyword, a ranking score of the search result based on a first relevance value used to measure relevance between the search result and the keyword element, a second relevance value used to measure relevance between the keyword and the keyword element, a corresponding data value of the highest advertisement revenue, and the category property score determined by the category property score determination module.

Optionally, corresponding to an implementation of the functions of the ranking score determination sub-unit 442, the unit may be divided into the following functional modules, which include:
a click rate determination module, configured to determine, for each search result found and each keyword element determined based on the keyword, a click rate associated with the search result when using the keyword element is used as a keyword of search; and
a ranking score determination module, configured to determine, for each search result found and each keyword element determined based on the keyword, a ranking score of the search result based on a first relevance value used to measure relevance between the search result and the keyword element, a second relevance value used to measure relevance between the keyword and the keyword element, a corresponding data value of the highest advertisement revenue determined by the highest advertisement revenue data value determination sub-unit, and the click rate determined by the click rate determination module.

Optionally, the embodiments of the present disclosure may further divide the structure of the above ranking score determination module into the following sub-modules:
a category property score determination sub-module, configured to determine, for each search result found and each keyword element determined based on the keyword, a category property score value which measures relevance between an information category to which the search result belongs and an information category to which the keyword element belongs;
a ranking score determination sub-module, configured to determine, for each search result found and each keyword element determined based on the keyword, a ranking score of the search result based on a first relevance value used to measure relevance between the search result and the keyword element, a second relevance value used to measure relevance between the keyword and the keyword element, a corresponding data value of the highest advertisement revenue, a corresponding click rate, and a corresponding category property score determined by the category property score determination sub-module.

Based on the above described apparatus of ranking search results, the embodiments of the present disclosure further provide a search apparatus. Specifically, the search apparatus may include the following functional units:
a search request receiving unit configured to receive a search request containing a keyword;
a search unit configured to find related search results based on the keyword contained in the search request that is received by the search request receiving unit;
a ranking information determination unit configured to determine ranking information that is used for instructing a ranking order of the search results found by the search unit (specifically, the ranking information determination unit includes the search result ranking apparatus as shown in FIG. 4 or an extended apparatus of ranking search results that is derived from the functions of the search result ranking apparatus); and
a sending unit configured to send the search results obtained by the search unit and the ranking information determined by the ranking information determination unit to a sender's apparatus corresponding to the search request and instruct the sender's apparatus to order the search results in accordance with the ranking information.

Through the search method provided in this embodiment, the number of search results obtained based on keyword elements is usually larger as compared with the number of search results obtained based on a long tail keyword. Therefore, the ranking information determined using the apparatus as shown in FIG. 4 or other extended apparatuses derived from that apparatus, for example, are more accurate. As such, the sender's apparatus may perform a more accurate ranking of the search results based on such ranking information, thus avoiding the problem of wasting a large amount of system resource that is caused by repeatedly sending search requests by the sender's apparatus to obtain an accurate ranking result due to inaccurate ranking of the search results.

One skilled in the art can alter or modify the disclosed method, system and apparatus in many different ways without departing from the spirit and the scope of this disclosure. Accordingly, it is intended that the present disclosure covers all modifications and variations which fall within the scope of the claims of the present disclosure and their equivalents.

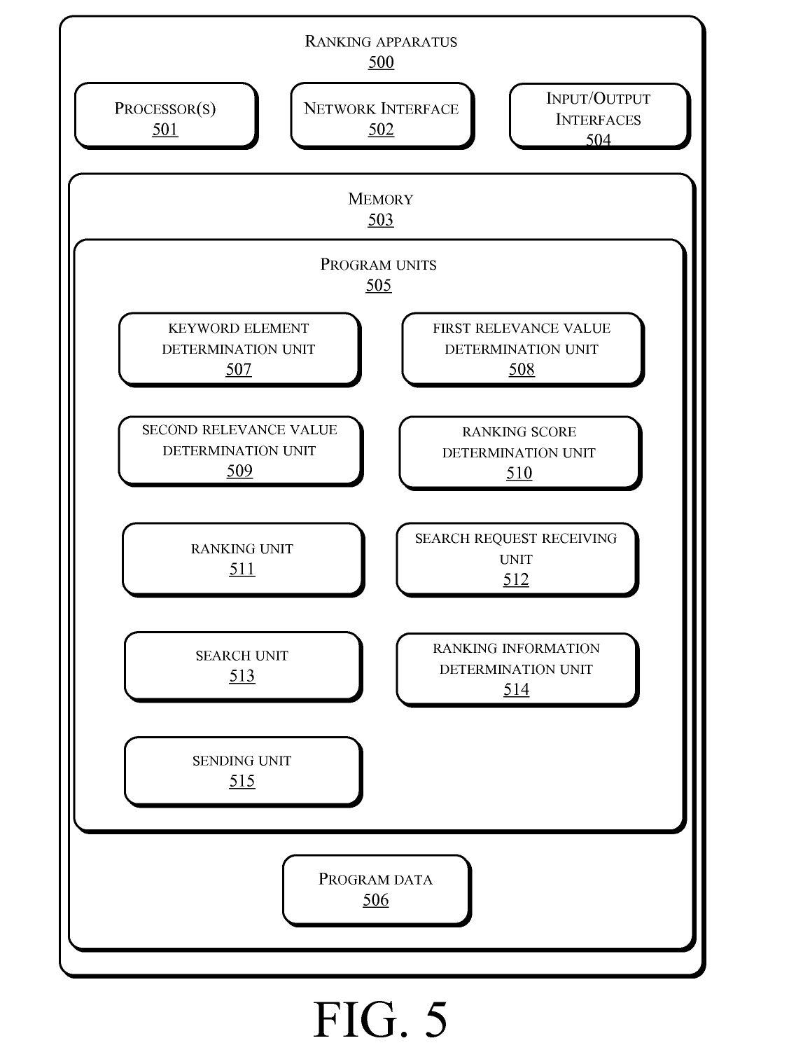

For example, FIG. 5 illustrates an exemplary apparatus 500, such as the apparatus as described above, in more detail. In one embodiment, the apparatus 500 can include, but is not limited to, one or more processors 501, a network interface 502, memory 503, and an input/output interface 504.

The memory 503 may include computer-readable media in the form of volatile memory, such as random-access memory (RAM) and/or non-volatile memory, such as read only memory (ROM) or flash RAM. The memory 503 is an example of computer-readable media.

Computer-readable media includes volatile and non-volatile, removable and non-removable media implemented in any method or technology for storage of information such as computer readable instructions, data structures, program modules, or other data. Examples of computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer-readable media does not include transitory media such as modulated data signals and carrier waves.

The memory 503 may include program units 505 and program data 506. In one embodiment, the program units 505 may include a keyword element determination unit 507, a first relevance value determination unit 508, a second relevance value determination unit 509, a ranking score determination unit 510, a ranking unit 511, a search request receiving unit 512, a search unit 513, a ranking information determination unit 514 and a sending unit 515. Details about these program units and any sub-units and/or modules thereof may be found in the foregoing embodiments described above.

What is claimed is:

1. A method of ranking search results, comprising:
determining one or more keyword elements related to a keyword;
for each search result obtained based on the keyword, separately determining, from pre-stored corresponding relationships among keyword elements, search results and first relevance values which are used to measure relevance between the search results and the keyword elements, first relevance values that correspond to both the search results obtained and the one or more keyword elements determined based on the keyword, and separately determining second relevance values that are used to measure relevance between the keyword and the determined keyword elements;
separately determining a ranking score of each search result obtained based on the keyword using the first relevance values and the second relevance values; and
determining ranking information that is used to instruct a ranking order of the search results based on the ranking score of each search result.

2. The method of claim 1, wherein separately determining a ranking score of each search result obtained based on the keyword using the first relevance values and the second relevance values comprises:
for each of the search results obtained based on the keyword, performing the following acts:
for each of the keyword elements, determining a data value of the highest advertisement revenue each time when the search result is presented with the keyword element being used as a keyword of search;
for each of the keyword elements, determining a ranking score of the search result based on a first relevance value used to measure relevance between the search result and the keyword element, a second relevance value used to measure relevance between the keyword and the keyword element and the data value of the highest advertisement revenue; and
selecting the highest score from the ranking score of each of the keyword elements as a ranking score of the search result.

3. The method of claim 2, wherein for each of the keyword elements, determining the ranking score of the search result based on the first relevance value used to measure relevance between the search result and the keyword element, the second relevance value used to measure relevance between the keyword and the keyword element and the data value of the highest advertisement revenue comprises:
for each of the keyword elements, determining a category property score used to measure relevance between an information category to which the search result belongs and an information category to which the keyword element belongs; and
for each of the keyword elements, determining the ranking score of the search result, based on the first relevance value used to measure the relevance between the search result and the keyword element, the second relevance value used to measure the relevance between the keyword and the keyword element, the data value of the highest advertisement revenue, and the category property score.

4. The method of claim 2, wherein for each of the keyword elements, determining the ranking score of the search result based on the first relevance value used to measure relevance between the search result and the keyword element, the second relevance value used to measure relevance between the keyword and the keyword element and the data value of the highest advertisement revenue comprises:
for each of the keyword elements, determining a click rate associated with the search result with the keyword element being used as the keyword of search;
for each of the keyword elements, determining the ranking score of the search result, based on the first relevance value used to measure the relevance between the search result and the keyword element, the second relevance value used to measure the relevance between the keyword and the keyword element, the data value of the highest advertisement revenue, and the click rate.

5. The method of claim 4, wherein for each of the keyword elements, determining the ranking score of the search result, based on the first relevance value used to measure the relevance between the search result and the keyword element, the second relevance value used to measure the relevance between the keyword and the keyword element, the data value of the highest advertisement revenue, and the click rate comprises:
for each of the keyword elements, determining a category property score used to measure relevance between an information category to which the search result belongs and an information category to which the keyword element belongs; and
for each of the keyword elements, determining the ranking score of the search result, based on the first relevance value used to measure the relevance between the search result and the keyword element, the second relevance value used to measure the relevance between the keyword and the keyword element, the data value of the highest advertisement revenue, the click rate, and the category property score.

6. The method of claim 1, wherein the keyword elements comprise keyword elements that are generated by splitting the keyword, keyword elements remaining after removing special characters from the keyword, keyword elements that have meanings close to the keyword, keyword elements determined to be related to an information category to which the keyword belongs, keyword elements that are determined based on probabilities of co-occurrence of other keywords and the keyword.

7. The method of claim 1, further comprising calculating the first relevance values that correspond to both the search results obtained and the one or more keyword elements determined based on the keyword using a Gradient Boosted Decision Tree (GBDT) or a linear model.

8. A search method comprising:
receiving a search request containing a keyword;
finding search results based on the keyword, and determining ranking information used for instructing a ranking order of the search results; and
sending the search results and the ranking information to a sender's apparatus corresponding to the search request and instructing the sender's apparatus to order the search results in accordance with the ranking information.

9. The method of claim 8, further comprising:
determining keyword elements related to the keyword;
for each search result obtained based on the keyword, separately determining, from pre-stored corresponding relationships among the keyword elements, the search results and first relevance values which are used to measure relevance between the search results and the keyword elements, first relevance values that correspond to both the search results and the keyword elements, and separately determining second relevance values that are used to measure relevance between the keyword and the determined keyword elements;
separately determining a ranking score of each search result obtained based on the keyword using the first relevance values and the second relevance values, wherein determining the ranking information comprising determining the ranking information that is used for instructing the ranking order of the search results based on the ranking score of each search result.

10. The method of claim 9, wherein separately determining a ranking score of each search result obtained based on the keyword using the first relevance values and the second relevance values comprises:
for each of the search results obtained based on the keyword, performing the following acts:
for each of the keyword elements, determining a data value of the highest advertisement revenue each time when the search result is presented with the keyword element being used as a keyword of search;
for each of the keyword elements, determining a ranking score of the search result based on a first relevance value used to measure relevance between the search result and the keyword element, a second relevance value used to measure relevance between the keyword and the keyword element and the data value of the highest advertisement revenue; and
selecting the highest score from the ranking score of each of the keyword elements as a ranking score of the search result.

11. The method of claim 10, wherein for each of the keyword elements, determining the ranking score of the search result based on the first relevance value used to measure relevance between the search result and the keyword element, the second relevance value used to measure relevance between the keyword and the keyword element and the data value of the highest advertisement revenue comprises:
for each of the keyword elements, determining a category property score used to measure relevance between an information category to which the search result belongs and an information category to which the keyword element belongs; and
for each of the keyword elements, determining the ranking score of the search result, based on the first relevance value used to measure the relevance between the search result and the keyword element, the second relevance value used to measure the relevance between the keyword and the keyword element, the data value of the highest advertisement revenue, and the category property score.

12. The method of claim 10, wherein for each of the keyword elements, determining the ranking score of the search result based on the first relevance value used to measure relevance between the search result and the keyword element, the second relevance value used to measure relevance between the keyword and the keyword element and the data value of the highest advertisement revenue comprises:
for each of the keyword elements, determining a click rate associated with the search result with the keyword element being used as the keyword of search;
for each of the keyword elements, determining the ranking score of the search result, based on the first relevance value used to measure the relevance between the search result and the keyword element, the second relevance value used to measure the relevance between the keyword and the keyword element, the data value of the highest advertisement revenue, and the click rate.

13. The method of claim 12, wherein for each of the keyword elements, determining the ranking score of the search result, based on the first relevance value used to measure the relevance between the search result and the keyword element, the second relevance value used to measure the relevance between the keyword and the keyword element, the data value of the highest advertisement revenue, and the click rate comprises:
for each of the keyword elements, determining a category property score used to measure relevance between an information category to which the search result belongs and an information category to which the keyword element belongs; and
for each of the keyword elements, determining the ranking score of the search result, based on the first relevance value used to measure the relevance between the search result and the keyword element, the second relevance value used to measure the relevance between the keyword and the keyword element, the data value of the highest advertisement revenue, the click rate, and the category property score.

14. The method of claim 8, wherein the keyword elements comprise keyword elements that are generated by splitting the keyword, keyword elements remaining after removing special characters from the keyword, keyword elements that have meanings close to the keyword, keyword elements determined to be related to an information category to which the keyword belongs, keyword elements that are determined based on probabilities of co-occurrence of other keywords and the keyword.

15. The method of claim 8, further comprising calculating the first relevance values that correspond to both the search results obtained and the one or more keyword elements determined based on the keyword using a Gradient Boosted Decision Tree (GBDT) or a linear model.

16. An apparatus comprising:
a keyword element determination unit configured to determine keyword elements related to the keyword;
a first relevance value determination unit configured to, for each search result obtained based on the keyword, separately determining, from pre-stored corresponding relationships among keyword elements, search results and first relevance values which are used to measure relevance between the search results and the keyword elements, first relevance values that correspond to both the search results obtained and the keyword elements determined based on the keyword, and separately determining second relevance values that are used to measure relevance between the keyword and the keyword elements determined by the keyword element determination unit;
a second relevance value determination unit configured to separately determine second relevance values that are used to measure relevance between the keyword and the keyword elements determined by the keyword element determination unit;
a ranking score determination unit configured to separately determine a ranking score of each search result obtained based on the keyword using the first relevance values determined by the first relevance value determination unit and the second relevance values determined by the second relevance value determination unit; and
a ranking unit configured to determine the ranking information used to instruct a ranking order of the search results in accordance with the ranking score of each search result determined by the ranking score determination unit.

17. The apparatus of claim 16, wherein the ranking score determination unit comprises:
a highest advertisement revenue data value determination sub-unit, configured to determine, for each search result found and each keyword element determined based on the keyword, a data value of the highest advertisement revenue obtained each time when the search result is presented with the keyword element being as a keyword;
a ranking score determination sub-unit, configured to determine, for each search result found and each keyword element determined based on the keyword, the ranking score of the search result based on the first relevance value used to measure the relevance between the search result and the keyword element, the second relevance value used to measure the relevance between the keyword and the keyword element, and the data value of the highest advertisement revenue determined by the highest advertisement revenue data value determination sub-unit; and
a ranking score selection sub-unit, configured to select the highest ranking score from the ranking of the keyword elements determined by the ranking score determination sub-unit as a ranking score of associated search result.

18. The apparatus of claim 17, wherein the ranking score determination sub-unit comprises:
a category property score determination module, configured to determine, for each search result found and each keyword element determined based on the keyword, a category property score value which measures relevance between an information category to which the search result belongs and an information category to which the keyword element belongs; and
a ranking score determination module, configured to determine, for each search result found and each keyword element determined based on the keyword, the ranking score of the search result based on the first relevance value used to measure relevance between the search result and the keyword element, the second relevance value used to measure relevance between the keyword and the keyword element, the data value of the highest advertisement revenue, and the category property score determined by the category property score determination module.

19. The apparatus of claim 17, wherein the ranking score determination sub-unit comprises:
a click rate determination module, configured to determine, for each search result found and each keyword element determined based on the keyword, a click rate associated with the search result when using the keyword element is used as a keyword of search; and
a ranking score determination module, configured to determine, for each search result found and each keyword element determined based on the keyword, the ranking score of the search result based on the first relevance value used to measure relevance between the search result and the keyword element, the second relevance value used to measure relevance between the keyword and the keyword element, the data value of the highest advertisement revenue determined by the highest advertisement revenue data value determination sub-unit, and the click rate determined by the click rate determination module.

20. The apparatus of claim 19, wherein the ranking score determination sub-unit comprises:
a category property score determination sub-module, configured to determine, for each search result found and each keyword element determined based on the keyword, a category property score value which measures relevance between an information category to which the search result belongs and an information category to which the keyword element belongs; and
a ranking score determination sub-module, configured to determine, for each search result found and each keyword element determined based on the keyword, the ranking score of the search result based on the first relevance value used to measure relevance between the search result and the keyword element, the second relevance value used to measure relevance between the keyword and the keyword element, the corresponding data value of the highest advertisement revenue, the click rate, and the category property score determined by the category property score determination sub-module.
